(19) United States
(12) Patent Application Publication
(10) Pub. No.: US 2010/0156950 A1
(43) Pub. Date: Jun. 24, 2010

(54) COLOR FILTER SUBSTRATE AND DISPLAY APPARATUS HAVING THE SAME

(76) Inventor: Sang-Jin Pak, Yongin-si (KR)

Correspondence Address: F. CHAU & ASSOCIATES, LLC, 130 WOODBURY ROAD, WOODBURY, NY, 11797, US

(21) Appl. No.: 12/535,345

(22) Filed: Aug. 4, 2009

(30) Foreign Application Priority Data
Aug. 5, 2008 (KR) 10-2008-0076671

(51) Int. Cl. G09G 5/10

(52) U.S. Cl. 345/690

(57) ABSTRACT

In a color filter substrate and a display apparatus having the color filter substrate, the color filter substrate includes a color filter part having at least two adjacent color filters having different colors that are repeatedly arranged in turn. An edge of the color filter part overlaps a light blocking layer pattern in a plan view, wherein no difference in a blocking amount occurs between red, green, and blue lights blocked by the light blocking layer pattern. As a result, deterioration in a display quality of the display apparatus, which is caused by the light blocking layer pattern blocking a light having a certain color, may be prevented.

### CROSS-REFERENCE TO RELATED APPLICATION

This application relies for priority upon Korean Patent Application No. 2008-76671 filed on Aug. 5, 2008, the contents of which are herein incorporated by reference in its entirety.

### BACKGROUND

1. Technical Field

The present invention relates to a color filter substrate and a display apparatus having the same, and more particularly, to a color filter substrate having a round-shaped light transmitting area and a display apparatus having the color filter substrate.

2. Discussion of the Related Art

A display device includes a color filter to display images with colors. The color filter receives white light and filters light having a certain wavelength of the white light. The color filter may include red, green and blue color filters, which respectively correspond to three primary colors of visible light, regularly arranged on a substrate. Various colors are realized according to combinations of the three colors obtained by filtering the white light through each of the red, green and blue color filters.

Round shaped display devices have been used. However, if the round shaped display device is manufactured by cutting edges of a conventional square shaped display device, a display quality of the round shape display device is deteriorated.

### SUMMARY OF INVENTION

Exemplary embodiments of the present invention provide a color filter substrate capable of improving a display quality, and a display apparatus having the color filter substrate.

In an exemplary embodiment of the present invention, a color filter substrate includes a substrate, a color filter part arranged on the substrate and including at least two color filters having different colors that are repeatedly arranged, and a first light blocking layer pattern arranged on the substrate to block a light exiting to an exterior after being transmitted through the substrate. The first light blocking layer pattern overlaps at least one edge portion of the color filter part in a plan view.

In an exemplary embodiment of the present invention, a display apparatus includes a first substrate including pixel areas and an edge area that surrounds the pixel areas, a second substrate facing the first substrate, pixels arranged in the pixel areas, respectively, a color filter part arranged on the second substrate and including at least two color filters having different colors that are repeatedly arranged, and a first light blocking layer pattern arranged on the second substrate in the edge area to block a light exiting to an exterior after being transmitted through the second substrate. The first light blocking layer pattern overlaps at least one edge portion of the color filter part in a plan view.

A display apparatus, according to an exemplary embodiment of the present invention, comprises a display area and a peripheral area that surrounds the display area, a color filter substrate, a color filter part arranged on the color filter substrate, the color filter part comprising a plurality of color filters having different colors that are repeatedly arranged along a predetermined direction, and a light blocking layer pattern arranged on the color filter substrate in the peripheral area, wherein the light blocking layer pattern overlaps a portion of the plurality of color filters arranged along the predetermined direction in a plan view.

An edge of the light blocking layer pattern overlapping the portion of the plurality of color filters may have a rounded shape.

The plurality of color filters may comprise a red color filter adjacent a blue color filter, and a green color filter adjacent the blue color filter, wherein the red, blue and green color filters are repeatedly arranged in turn along the predetermined direction.

The plurality of color filters may comprise a red color filter adjacent a green color filter, and a blue color filter adjacent the green color filter, wherein the red, green and blue color filters are repeatedly arranged in turn along the predetermined direction.

According to the embodiments of the present invention, even though the color filter part overlaps the light blocking layer pattern in a plan view, no difference in a blocking amount occurs between lights having different colors, which are blocked by the light blocking layer pattern, since at least two adjacent color filters having different colors are repeatedly arranged on the color filter substrate. Thus, deterioration in a display quality of the display apparatus, which is caused by the light blocking layer pattern blocking light having a certain color, may be prevented.

### BRIEF DESCRIPTION OF THE DRAWINGS

Exemplary embodiments of the present invention will become readily apparent by reference to the following detailed description when considered in conjunction with the accompanying drawings wherein:

FIG. 1 is a perspective view showing a display apparatus according to an exemplary embodiment of the present invention;

FIG. 2 is an enlarged view showing a portion A1 of the display apparatus of FIG. 1;

FIG. 3 is a cross-sectional view taken along a line I-I′ of FIG. 2;

FIG. 4 is a perspective view showing a display apparatus according to an exemplary embodiment of the present invention;

FIG. 5 is an enlarged view showing a portion A2 of FIG. 4; and

FIG. 6 is a cross-sectional view taken along a line II-IF of FIG. 5.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers may refer to like elements throughout. As used herein, the term “and/or” includes any and all combinations of one or more of the associated listed items.

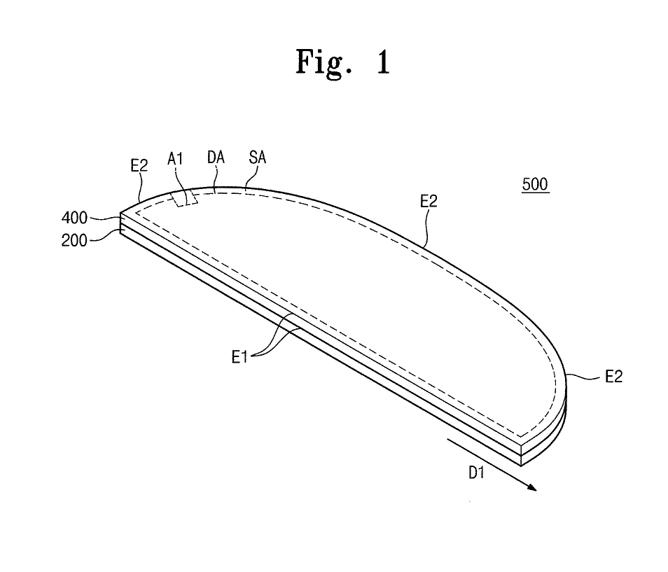

FIG. 1 is a perspective view showing a display apparatus according to an exemplary embodiment of the present invention.

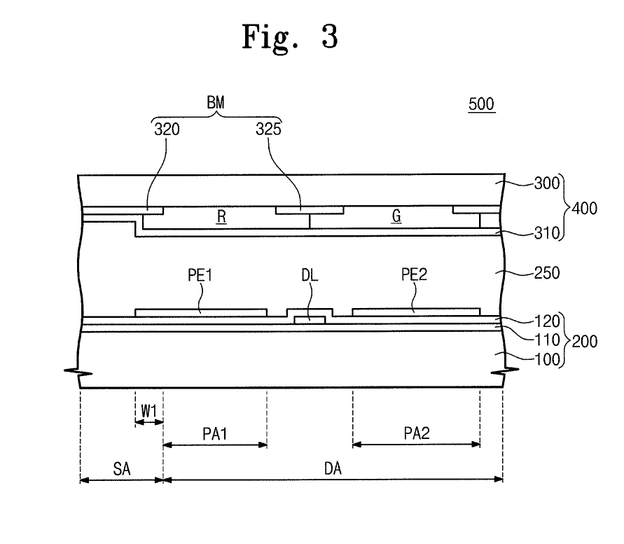

Referring to FIG. 1, a display apparatus 500 includes a display substrate 200, a color filter substrate 400 facing the display substrate 200, and liquid crystal 250 (refer to FIG. 3) interposed between the display substrate 200 and the color filter substrate 400.

Each of the display substrate 200 and the color filter substrate 400 includes a round shaped edge in a plan view. More particularly, each of the display substrate 200 and the color filter substrate 400 includes a first edge E1 and a second edge E2. The first edge E1 extends in parallel to a first direction D1, and the second edge E2 has a rounded shape that extends from both ends of the first edge E1.

The display substrate 200 includes a display area DA in which a plurality of pixel areas PA are arranged and a peripheral area SA surrounding the display area DA. In the display substrate 200, an image is displayed in the display area DA, and an edge of the display area DA adjacent to the second edge E2 has a rounded shape corresponding to the rounded shape of the second edge E2.

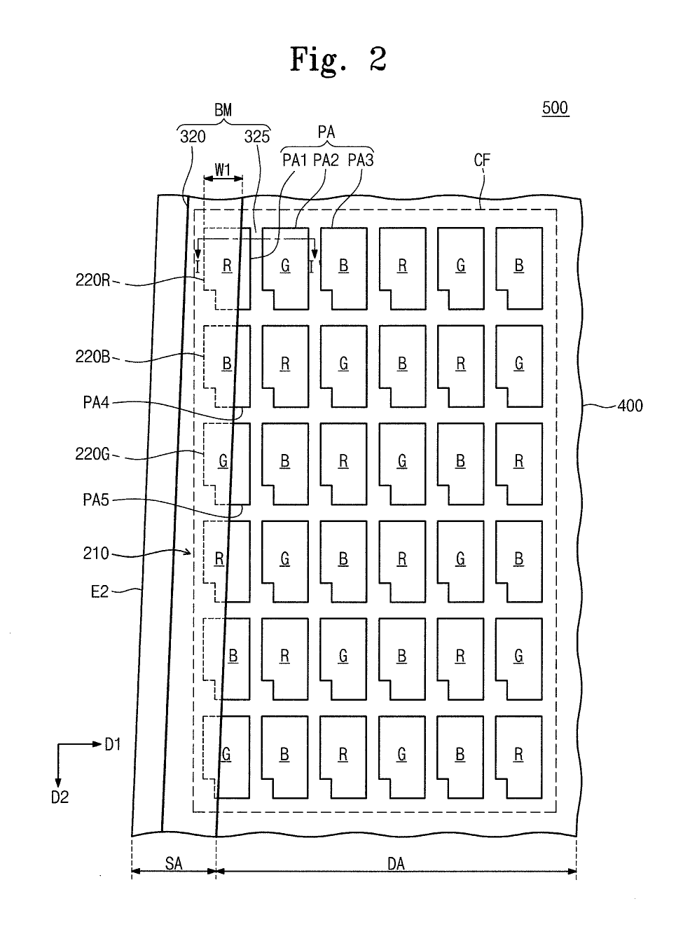

FIG. 2 is an enlarged view showing a portion A1 of the display apparatus of FIG. 1. FIG. 2 shows, in further detail, a structure of the color filter substrate 400 corresponding to a first area A1. FIG. 3 is a cross-sectional view taken along a line I-I′ of FIG. 2.

Referring to FIGS. 2 and 3, the color filter substrate 400 includes a second substrate 300, a color filter part CF, light blocking layer patterns BM, and a common electrode 310.

The color filter part CF includes red color filters R, blue color filters B, and green color filters G. Each color filter has a relatively short side in parallel with the first direction D1 and a relatively long side in parallel with a second direction D2 that is substantially perpendicular to the first direction D1.

The red, blue, and green color filters R, B, and G are arranged on the second substrate 300 in a one-to-one correspondence with the pixel areas PA. For example, the red color filter R is arranged corresponding to a first pixel area PA1, the green color filters G are arranged corresponding to a second pixel area PA2 and a fifth pixel area PA5, and the blue color filters B are arranged corresponding to a third pixel area PA3 and a fourth pixel area PA4.

The color filters are repeatedly arranged in an order of the red color filter R, the green color filter G, and the blue color filter B along the first direction D1 of the color filter part CF. In addition, the color filters are repeatedly arranged in an order of the red color filter R, the blue color filter B, and the green color filter G along the second direction D2 of the color filter part CF. Thus, color filters that are arranged adjacent to each other in the first and second directions D1 and D2 have different colors from each other.

In an alternative embodiment, the color filters may be repeatedly arranged in an order of the red color filter R, the blue color filter B, and the green color filter G along the first direction D1, and the color filters may be repeatedly arranged in an order of the red color filter R, the green color filter G, and the blue color filter B along the second direction D2.

The light blocking layer patterns BM include a first light blocking layer pattern 320 and a second light blocking layer pattern 325. The first and second light blocking layer patterns 320 and 325 include a metal material, such as chromium, to block light exiting to an exterior after being transmitted through the color filter 400.

The first light blocking layer pattern 320 is arranged on the second substrate 300 corresponding to the peripheral area SA and extends in parallel with the fist edge E1 and the second edge E2. Thus, a portion of the first light blocking layer pattern 320 has a rounded shape corresponding to the rounded shape of the second edge E2, as shown in a plan view.

The second light blocking layer pattern 325 includes the same material as the first light blocking layer pattern 320 and is arranged between two color filters that are adjacent to each other in the first and second directions D1 and D2. Also, according to an exemplary embodiment, the second light blocking layer pattern 325 branches from the first light blocking layer pattern 320.

An edge portion 210 of the color filter part CF overlaps the first light blocking layer pattern 320, as shown in the plan view of FIG. 2. As a result, color filters that are arranged at an outermost column of the color filter part CF and adjacent to the edge portion 210 of the color filter part CF partially overlap the first light blocking layer pattern 320 in a plan view.

More particularly, a first overlap part 220R corresponding to a portion of the red color filter R arranged in the first pixel area PA1 overlaps the first light blocking layer pattern 320 by a first width W1 as a maximum allowable overlapping width. In addition, a second overlap part 220B corresponding to a portion of the blue color filter B arranged in the fourth pixel area PA4 overlaps the first light blocking layer pattern 320, and a third overlap part 220G corresponding to a portion of the green color filter G arranged in the fifth pixel area PA5 overlaps the first light blocking layer pattern 320.

Since the first overlap part 220R overlaps the first light blocking layer pattern 320, a light applied to the first overlap part 220R is blocked by the first light blocking layer pattern 320. Thus, an amount of red light exiting to an exterior after being transmitted through the red color filter R arranged in the first pixel area PA1 is inversely proportional to a size of the first overlap part 220R. Similarly, an amount of blue light exiting to the exterior after being transmitted through the blue color filter B arranged in the fourth pixel area PA4 is inversely proportional to a size of the second overlap part 220B, and an amount of green light exiting to the exterior after being transmitted through the green color filter G arranged in the fifth pixel area PA5 is inversely proportional to a size of the third overlap part 220G.

Since the first light blocking layer pattern 320 has a rounded shape in a plan view, the first, second, and third overlap parts 220R, 220B, and 220G have different sizes from each other. However, as described above, the color filters positioned at the outermost column of the color filter part CF and adjacent to the edge portion 210 of the color filter part CF are repeatedly arranged in an order of the red color filter R, the blue color filter B, and the green color filter G in the first direction D1, and as a result, no difference in the blocking amount occurs between the red, green, and blue lights blocked by the first light blocking layer pattern 320 in the edge portion 210. Therefore, even though a brightness level of the display apparatus 500 may be reduced in the edge portion 210, a variation of color in the edge portion 210, which is caused by light loss of a certain color among lights exiting to the exterior after being transmitted through the edge portion 210, may be minimized.

The common electrode 310 is arranged on the second substrate 300 to cover the light blocking layer patterns BM and the color filter part CF. The common electrode 310 forms an electric field with each pixel electrode, e.g., a first pixel electrode PE1 and a second pixel electrode PE2, respectively, to control an alignment state of the liquid crystal 250.

The display apparatus 200 includes a first substrate 100, gate lines (not shown), data lines including the data line DL, thin film transistors (not shown), and pixel electrodes that are electrically connected to the thin film transistors in one-to-one correspondence.

The gate line is insulated from the data line DL by a gate insulating layer 110, and pixel areas are defined by the gate lines and the data lines that cross each other. Each thin film transistor is arranged in a corresponding pixel area of the pixel areas to be electrically connected to a corresponding gate line of the gate lines and a corresponding data line DL of the data lines, thereby switching a data signal that is applied to each pixel.

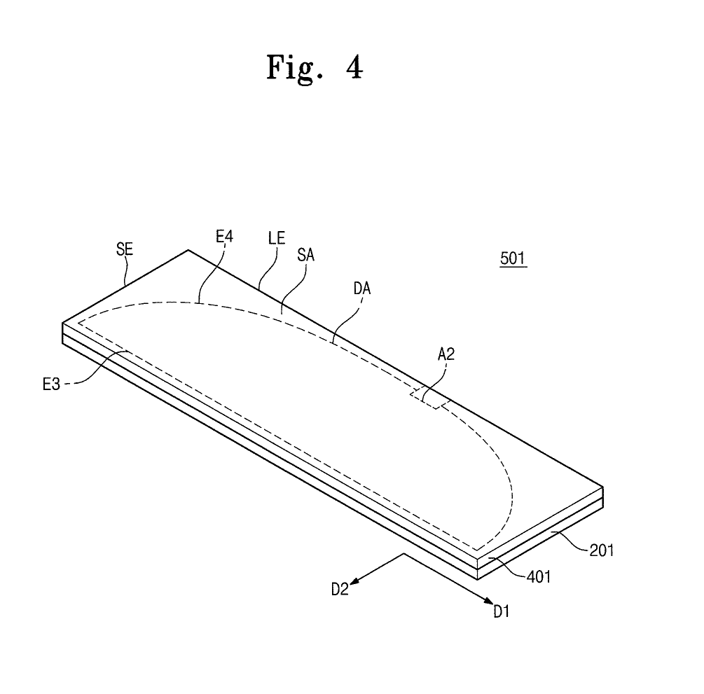

FIG. 4 is a perspective view showing a display apparatus according to an exemplary embodiment of the present invention.

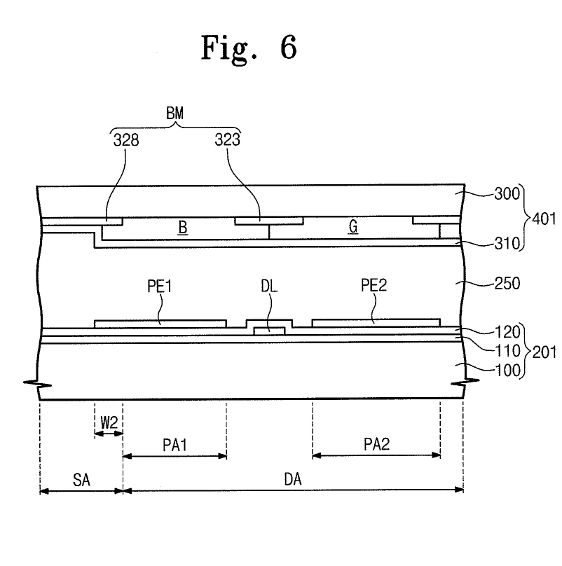

Referring to FIG. 4, a display apparatus 501 includes a display substrate 201, a color filter substrate 401 facing the display substrate 201, and liquid crystal 250 (refer to FIG. 6) interposed between the display substrate 201 and the color filter substrate 401.

Each of the display substrate 201 and the color filter substrate 401 has a rectangular shape. More particularly, each of the display substrate 201 and the color filter substrate 401 has relatively long sides LE extended in parallel with a first direction D1 and relatively short sides SE extended in parallel with a second direction D2 that is substantially perpendicular to the first direction D1.

The display substrate 201 includes a display area DA in which a plurality of pixel areas is defined and a peripheral area SA surrounding the display area DA. In the display substrate 201, an image is displayed in the display area DA. An edge E3 of the display area DA extends in parallel with the first direction D1, and an edge E4 of the display area DA extends from both ends of the edge E3 to have a rounded shape.

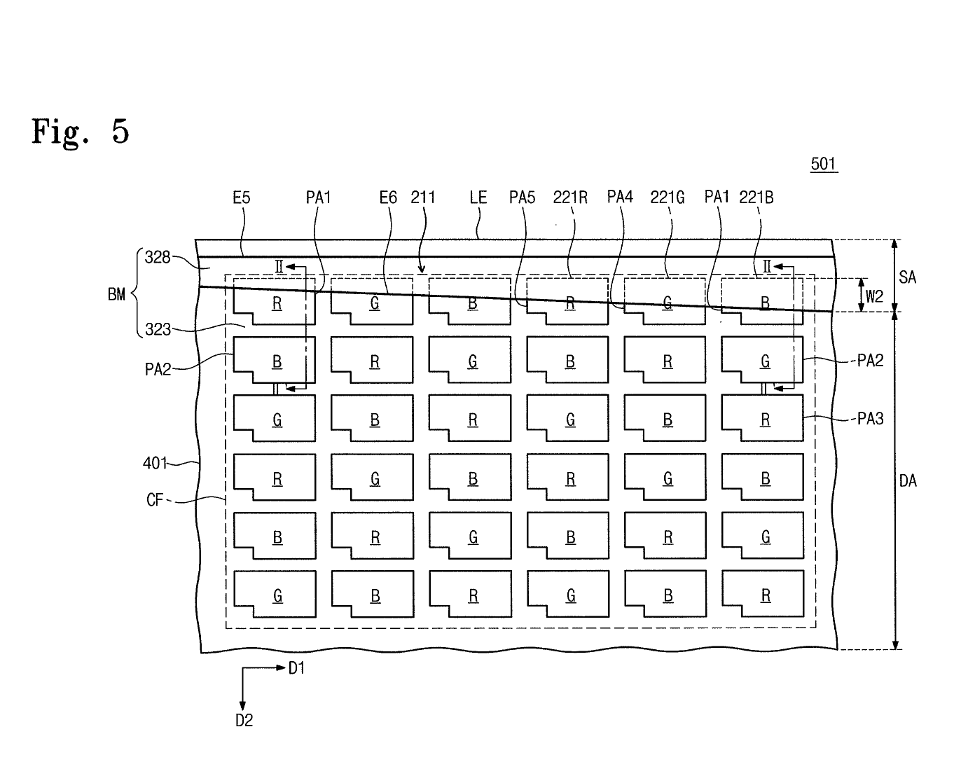

FIG. 5 is an enlarged view showing a portion A2 of FIG. 4. More particularly, FIG. 5 shows a structure of the color filter 401 corresponding to the second area A2 in detail. FIG. 6 is a cross-sectional view taken along a line II-II′ of FIG. 5. In FIGS. 5 and 6, the same reference numerals denote the same elements in FIGS. 2 and 3, and thus the detailed descriptions of the same elements are omitted.

Referring to FIGS. 5 and 6, the color filter substrate 401 includes a second substrate 300, a color filter part CF, light blocking layer patterns BM, and a common electrode 310.

The color filter part CF includes red color filters R, blue color filters B, and green color filters G, and each color filter has relatively long sides extended in parallel along the first direction D1 and relatively short sides extended in parallel along the second direction D2 that is substantially perpendicular to the first direction D1.

The red, blue, and green color filters R, B, and G are arranged on the second substrate 300 corresponding to the pixel areas in one-to-one correspondence. For instance, the blue color filter B is arranged corresponding to a first pixel area PA1, the green color filter G is arranged corresponding to each of a second pixel area PA2 and a fourth pixel area PA4, and the red color filter R is arranged corresponding to each of a third pixel area PA3 and a fifth pixel area PA5.

In the color filter part CF, the color filters are repeatedly arranged in an order of the red color filter R, the green color filter Gy and the blue color filter B along the first direction D1. Also, the color filters are repeatedly arranged in an order of the red color filter R, the blue color filter B, and the green color filter G along the second direction D2 in the color filter part CF. Thus, color filters arranged adjacent in the first and second directions D1 and D2 have different colors from each other.

In an alternative embodiment, the color filters may be repeatedly arranged in an order of the red color filter R, the blue color filter B, and the green color filter G along the first direction D1 in the color filter part CF, and the color filters may be repeatedly arranged in an order of the red color filter R, the green color filter G, and the blue color filter B along the second direction D2 in the color filter part CF.

The light blocking layer patterns BM include a first light blocking layer pattern 328 and a second light blocking layer pattern 323. The first and second light blocking layer patterns 328 and 323 may include a metal material, such as chromium, to block a light exiting to an exterior after being transmitted through the color filter substrate 410.

The first light blocking layer pattern 328 is arranged on the second substrate 300 corresponding to the peripheral area SA. The first light blocking layer pattern 328 has a an edge E5 and an edge E6. The edge E5 is in parallel with the relatively long side LE of the color filter substrate 401, and the edge E6 has a rounded shape corresponding to the edge E4 (shown in FIG. 4) of the display area DA. According to an exemplary embodiment, since the display area DA is defined by the first light blocking layer pattern 328 that blocks the light being transmitted through the color filter substrate 401, the edge E4 and the edge E6 are placed at the same position in a plan view.

The second light blocking layer pattern 323 includes the same material as the first light blocking layer pattern 328 and is arranged between the color filters adjacent to each other in the first and second directions D1 and D2. According to an exemplary embodiment, the second light blocking layer pattern 323 branches from the first light blocking layer pattern 328.

An edge portion 211 of the color filter part CF overlaps the first light blocking layer pattern 328. Thus, color filters that are arranged at an outermost row of the color filter part CF and adjacent to the edge portion 211 of the color filter part CF partially overlap the first light blocking layer pattern 320, as shown in a plan view of FIG. 5.

More particularly, a first overlap part 221B corresponding to a portion of the blue color filter B arranged in the first pixel area PA1 overlaps the first light blocking layer pattern 328 by a second width W2 as a maximum allowable overlapping width. In addition, a second overlap part 221G corresponding to a portion of the green color filter G arranged in the fourth pixel area PA4 overlaps the first light blocking layer pattern 328, and a third overlap part 221R corresponding to a portion of the red color filter R arranged in the fifth pixel area PA5 overlaps the first light blocking layer pattern 328.

Since the first overlap part 221B overlaps the first light blocking layer pattern 328, a light transmitted through the first overlap part 221B is blocked by the first light blocking layer pattern 328. Thus, an amount of blue light exiting to an exterior after being transmitted through the blue color filter B arranged in the first pixel area PA1 is inversely proportional to a size of the first overlap part 221B. Similarly, an amount of green light exiting to an exterior after being transmitted through the green color filter G arranged in the fourth pixel area PA4 is inversely proportional to a size of the second overlap part 221G, and an amount of red light exiting to an exterior after being transmitted through the red color filter R arranged in the fifth pixel area PA5 is inversely proportional to a size of the third overlap part 221R.

Since the edge E6 of the first light blocking layer pattern 328 has a rounded shape in a plan view, the first, second, and third overlap parts 221B, 221G, and 221R have different sizes from each other. However, as described above, the color filters positioned at the outermost row of the color filter part CF and adjacent to the edge portion 211 of the color filter part CF are repeatedly arranged in an order of the red color filter R, the green color filter G, and the blue color filter B in the first direction D1, and, as a result, no difference in the blocking amount occurs between the red, green, and blue lights blocked by the first light blocking layer pattern 328 in the edge portion 211. Therefore, even though a brightness level of the display apparatus 501 may be reduced in the edge portion 211, a variation of color in the edge portion 211 of the display apparatus 501, which is caused by light loss of a certain color, may be minimized.

According to the color filter substrate and the display apparatus of embodiments of the present invention, even though the color filter part overlaps the first light blocking layer pattern in a plan view, no difference in a blocking amount occurs between lights having different colors, which are blocked by the first light blocking layer pattern, since at least two adjacent color filters having different colors are repeatedly arranged on the color filter substrate. Thus, deterioration in a display quality of the display apparatus, which is caused by the first light blocking layer pattern blocking light having a certain color, may be prevented.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A color filter substrate comprising:
a substrate;
a color filter part arranged on the substrate, the color filter part comprising at least two color filters having different colors that are repeatedly arranged; and
a first light blocking layer pattern arranged on the substrate, wherein the first light blocking layer pattern overlaps at least one edge portion of the color filter part in a plan view.

2. The color filter substrate of claim 1, wherein the color filter part comprises:
a red color filter;
a blue color filter; and
a green color filter, and wherein
the red color filter, the blue color filter, and the green color filter are repeatedly arranged in turn along a column direction of the color filter part, and the red color filter, the green color filter, and the blue color filter are repeatedly arranged in turn along a row direction of the color filter part.

3. The color filter substrate of claim 1, wherein the color filter part comprises:
a red color filter;
a blue color filter; and
a green color filter, and wherein
the red color filter, the green color filter, and the blue color filter are repeatedly arranged in turn along a column direction of the color filter part, and the red color filter, the blue color filter, and the green color filter are repeatedly arranged in turn along a row direction of the color part.

4. The color filter substrate of claim 1, wherein the first light blocking layer pattern has a rounded shape in a plan view.

5. The color filter substrate of claim 4, wherein an edge portion of the substrate, which is adjacent to the first light blocking layer pattern, has a rounded shape corresponding to the rounded shape of the first light blocking layer pattern.

6. The color filter substrate of claim 1, wherein the substrate has a rectangular shape in a plan view, and at least one edge portion of the first light blocking layer pattern has a rounded shape in the plan view.

7. The color filter substrate of claim 1, further comprising a second light blocking layer pattern that includes a same material as the first light blocking layer pattern, the second light blocking layer pattern being arranged on the substrate between two adjacent color filters.

8. A display apparatus comprising:
a first substrate including pixel areas and an edge area that surrounds the pixel areas;
a second substrate facing the first substrate;
pixels arranged in the pixel areas, respectively;
a color filter part arranged on the second substrate, the color filter part comprising at least two color filters having different colors that are repeatedly arranged; and
a first light blocking layer pattern arranged on the second substrate in the edge area, wherein the first light blocking layer pattern overlaps at least one edge portion of the color filter part in a plan view.

9. The display apparatus of claim 8, wherein the color filter part comprises:
a red color filter;
a blue color filter; and
a green color filter, and wherein
the red color filter, the blue color filter, and the green color filter are repeatedly arranged in turn along a column direction of the color filter part, and the red color filter, the green color filter, and the blue color filter are repeatedly arranged in turn along a row direction of the color filter part.

10. The display apparatus of claim 8, wherein the color filter part comprises:
a red color filter;
a blue color filter; and
a green color filter, and wherein
the red color filter, the green color filter, and the blue color filter are repeatedly arranged in turn along a column direction of the color filter part, and the red color filter, the blue color filter, and the green color filter are repeatedly arranged in turn along a row direction of the color part.

11. The display apparatus of claim 8, wherein the first light blocking layer pattern has a rounded shape in a plan view.

12. The display apparatus of claim 11, wherein each edge of the first and the second substrate, which is adjacent to the first light blocking layer pattern, has a rounded shape corresponding to the rounded shape of the first light blocking layer pattern.

13. The display apparatus of claim 8, wherein each of the first substrate and the second substrate has a rectangular shape in a plan view, and at least one edge portion of the first light blocking layer pattern has a rounded shape in a plan view.

14. The display apparatus of claim 8, further comprising a second light blocking layer pattern comprising a same material as the first light blocking layer pattern, the second light blocking layer pattern being arranged on the second substrate between two adjacent color filters.

15. The display apparatus of claim 8, further comprising:
liquid crystal interposed between the first substrate and the second substrate; and
a common electrode arranged on the second substrate to face the pixels.

16. A display apparatus comprising:
a display area and a peripheral area that surrounds the display area;
a color filter substrate;
a color filter part arranged on the color filter substrate, the color filter part comprising a plurality of color filters having different colors that are repeatedly arranged along a predetermined direction; and
a light blocking layer pattern arranged on the color filter substrate in the peripheral area, wherein the light blocking layer pattern overlaps a portion of the plurality of color filters arranged along the predetermined direction in a plan view.

17. The display apparatus of claim 16, wherein an edge of the light blocking layer pattern overlapping the portion of the plurality of color filters has a rounded shape.

18. The display apparatus of claim 16, wherein the plurality of color filters comprises a red color filter adjacent a blue color filter, and a green color filter adjacent the blue color filter, wherein the red, blue and green color filters are repeatedly arranged in turn along the predetermined direction.

19. The display apparatus of claim 16, wherein the plurality of color filters comprises a red color filter adjacent a green color filter, and a blue color filter adjacent the green color filter, wherein the red, green and blue color filters are repeatedly arranged in turn along the predetermined direction.
